(19) United States
(12) Patent Application Publication
(10) Pub. No.: US 2023/0175251 A1
(43) Pub. Date: Jun. 8, 2023

(54) STRONG ANCHOR

(71) Applicant: Nam Hyun JO, Yangsan-si (KR)

(72) Inventor: Nam Hyun JO, Yangsan-si (KR)

(21) Appl. No.: 17/925,327

(22) PCT Filed: May 15, 2020
(86) PCT No.: PCT/KR2020/006399

§ 371 Date: Nov. 15, 2022

(30) Foreign Application Priority Data
May 15, 2020 (KR) 10-2020-0058124

(51) Int. Cl. E04B 1/41

(52) U.S. Cl. CPC E04B 1/4121; E04B 1/4135

(57) ABSTRACT

According to the present invention, a body of an anchor bolt of a certain standard is inserted into a hole drilled in the ceiling, floor, or wall of concrete, and a wedge bolt is inserted into a body screw, then by rotating it in a tightening direction, a wedge portion of the wedge bolt is squashed into a spread portion of the anchor body with force of the screw so that it is firmly fixed, and the inserted wedge bolt may be rotated so that it may be loosened and extracted, so that it is possible to easily carry out demolishing work.

### TECHNICAL FIELD

The present invention relates to a strong anchor, and more particularly, to a strong anchor that may be installed and fixed in a hole drilled in a floor, wall, or ceiling of concrete to fix an object to be fixed in concrete.

### BACKGROUND OF THE INVENTION

Generally, strong anchors are used for cable tray support work, facility pipe support work, and fixing work for various devices for accommodating electric and communication cables of medium and large buildings such as apartments or buildings.

A strong anchor generally consists of a tubular anchor body in which a lower portion of the body is incised and openable, and a wedge formed in a tapered shape inserted into a bottom portion of the anchor body to expand a diameter thereof.

In addition, after being inserted into an anchor installation hole, a bolt is rotated so that an extension nut fastened to the bolt comes close to a cylindrical sleeve and comes into close contact, and when the bolt is continuously rotated, it is installed in a hole drilled in the floor, wall or ceiling of concrete by the expansion nuts on both sides of the cylindrical sleeve.

However, the conventional strong anchor described above is inserted into a drilled hole during installation to fix a nut-shaped wedge by rotating a bolt, or to insert and fix it in concrete by hitting the anchor body using a jig and a hammer, but in this case, a small safety accident such as hitting a hand while hammering may occur, and inconvenience of fixing operation may occur.

In addition, there is a problem in that it is difficult to remove the anchor bolt fixed to a wall, floor, ceiling, and the like when a fixing device is dismantled.

### SUMMARY OF THE INVENTION

The present invention has been made in an effort to a strong anchor that has a safe, simple, and robust fitting structure that is installed and fixed in a hole drilled in concrete, and has a structure in which a wedge bolt is inserted into a body thread portion and rotated to tighten, and a wedge portion of a wedge bolt pushes and enters a spread portion of the anchor body with force of a screw and fixes it in order to spread and fix a spread portion of an anchor body.

Particularly, the present invention has been made in an effort to provide a strong anchor that may facilitate demolition work by rotating an inserted wedge bolt to loosen it and pulling it out.

An embodiment of the present invention provides a strong anchor including: a tubular anchor body; a body thread portion formed on an inner circumferential surface of the anchor body; a spread portion in which a plurality of incision grooves is formed in a lower portion of the anchor body; a protrusion formed with a plurality of protrusions having a triangular structure of a screw thread shape on an outer circumferential surface of the spread portion; a bolt insertion fixing portion having a jaw formed on an upper portion of the anchor body; and a wedge bolt 20 inserted into the body thread portion.

The wedge bolt includes a wedge bolt portion that is rotated in a thread direction to correspond to the body thread portion and coupled thereto and a conical wedge portion integrally connected to a lower portion of the wedge bolt portion, and

when the wedge bolt is rotated in a direction, as the wedge bolt is squashed into the lower portion of the body thread portion so that spread portion is widened, the protruding portion formed on the outer circumferential surface of the spread portion is widened and fixed to an object to be fixed.

According, to the present invention, a body of an anchor bolt of a certain standard is inserted into a hole drilled in the ceiling, floor, or wall of concrete, and a wedge bolt is inserted into a body screw, then by rotating it in a tightening direction, a wedge portion of the wedge bolt is squashed into a spread portion of the anchor body with force of the screw so that it may be firmly fixed, and the inserted wedge bolt may be rotated so that it may be loosened and extracted, so that it is possible to easily carry out demolishing work.

### BRIEF DESCRIPTION OF THE DRAWINGS

FIG. 1 illustrates a strong anchor according to embodiments of the present invention.

FIG. 2 illustrates a wedge bolt according to embodiments of the present invention.

### DETAILED DESCRIPTION OF THE EMBODIMENTS

Hereinafter, a preferred embodiment of the present invention will be described in detail with reference to the accompanying drawings.

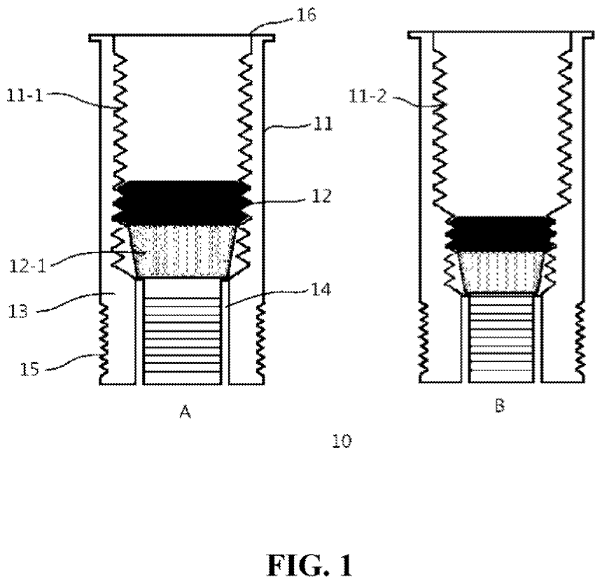

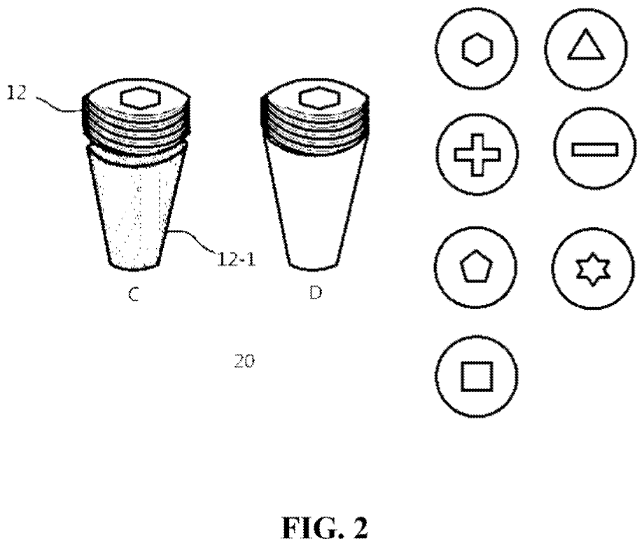

FIG. 1 ‘A’ illustrates a cross-sectional view of a strong anchor 10 according to an embodiment of the present invention, FIG. 1 ‘B’ illustrates a cross-sectional view of a strong anchor 10 according to another embodiment of the present invention, and FIG. 2 illustrates a perspective view of a wedge bolt 20 according, to various embodiments of the present invention.

Referring to the drawings, the strong anchor 10 according to the embodiment of the present invention includes: a tubular anchor body 11; a body thread portion 11-1 formed on an inner circumferential surface of the anchor body 11; a spread portion 13 in which a plurality of incision grooves 14 is formed in a lower portion of the anchor body 11; a protrusion 15 formed with a plurality of protrusions having a triangular structure of a screw thread shape on an outer circumferential surface f the spread portion 13; a bolt insertion fixing portion 16 having a jaw formed on an upper portion of the anchor body 11; and a wedge bolt 20 inserted into the body thread portion 11-1.

In addition, the wedge bolt 20 includes a wedge bolt portion 12 that is rotated in a thread direction to correspond to the body thread portion 11-1 and coupled thereto and a conical wedge portion 12-1 integrally connected to a lower portion of the wedge bolt portion 12.

In addition, when the wedge bolt 20 is rotated in a locking direction, while the wedge bolt 20 is inserted and entered into the lower portion of the body thread portion 11-1 and the spread portion 13 is opened and spread, the protruding 15 formed on the outer circumferential surface of the spread portion 13 is spread and fixed to an object to be fixed.

In addition, the wedge bolt 20 is separable into the conical wedge portion 12-1 and the wedge bolt portion 12.

In addition, a fastener (unsigned) of the wedge bolt portion 1 is formed to have one of hexagonal, pentagonal, quadrangular, triangular, linear, cross, and star shapes.

A body thread portion 11-2 according to another embodiment of the present invention includes a first hollow body thread portion and a second hollow body thread portion smaller in size than the first body thread portion.

Hereinafter, a configuration and operation of the strong anchor 10 according to the embodiments of the present invention will be described in detail as follows.

The strong anchor 10 according to the present invention includes the anchor body 11 and the wedge bolt 20 as shown in FIG. 1 and FIG. 2 shown in preferred embodiments.

In more detail, the strong anchor 10 according to the embodiment of the present invention includes, as shown in FIG. 1 ‘A’, the tubular anchor body 11, the body thread portion 11-1 formed on the inner circumferential surface of the anchor body 11, the spread portion 13 in which the plurality of incision grooves 14 is formed in the lower portion of the anchor body 11, the protrusion 1 formed with the plurality of protrusions having the triangular structure of the screw thread shape on the outer circumferential surface of the spread portion 13, the bolt insertion fixing portion 16 having the jaw formed on the upper portion of the anchor body 11, and the wedge bolt 20 inserted into the body thread portion 11-1.

In addition, the wedge bolt 20 according to the embodiment of the present invention includes the wedge bolt portion 12 that is rotated in the thread direction to correspond to the body thread portion 11-1 and coupled thereto and the conical wedge portion 12-1 integrally connected to the lower portion of the wedge bolt portion 12.

First, the anchor body 11 proposed by the present invention is formed in a tubular shape, and the bolt insertion fixing portion 16 having a jaw equal to a standard of a length of an anchor drilled in concrete is formed on the upper portion of the anchor body 11.

In addition, the anchor body 11 is formed of the body thread portion 11-1 and the spread portion 13; and when the wedge bolt 20 configured of the conical wedge portion 12-1 and the wedge bolt portion 12 is inserted into the body thread portion 11-1 and rotated in the locking direction, the protruding portion 15 is squashed and fixed into the concrete as the plurality of incision grooves 14 and the spread portion 13 configuring the protrusions 15 are spread.

That is, in the strong anchor 10 according to the embodiment of the present invention, the anchor body 11 is formed of the body thread portion 11-1 and the spread portion 13; and when the wedge bolt 20 configured of the conical wedge portion 12-1 and the wedge bolt portion 12 is inserted and rotated in the locking direction, the protruding portion 15 is squashed and fixed into the concrete as the plurality of incision grooves 14 and the spread portion 13 configuring the protrusions 15 are spread, so that h object to be fixed may be installed.

Here, the body thread portion 11-1 is formed at one side of the inner circumferential surface of the anchor body 11, and a thread is formed on the inner circumferential surface to be screwed and loosened of the wedge bolt portion 12, and may also be screwed with the object to be fixed.

Accordingly, when the wedge bolt 20 is rotated in the locking direction, while the wedge bolt 20 is inserted and entered into the lower portion of the body thread portion 11-1 and the spread portion 13 is opened and spread, the protruding 15 formed on the outer circumferential surface of the spread portion 13 is spread and fixed to the object to be fixed.

In addition, the wedge bolt 20 is separable into the conical wedge portion 12-1 and the wedge bolt portion 12, as shown in C of FIG. 2, so that the conical wedge 12-1 formed at various inclinations on the lower portion of the wedge bolt 12 is detachable, thus by using the conical wedge portion 12-1 with different inclinations in consideration of the anchor length and the like, tightening and loosening may be made more easily than in the prior art.

Here, the wedge bolt 20 is inserted into the anchor body 11 and rotated in the tightening direction to allow the spread portion 13 to be spread by the force of the screw thread.

That is, the wedge bolt 20 includes the conical wedge portion 12-1 and the wedge bolt portion 12; the wedge portion 12-1 and the wedge bolt portion 12 are separately configured and separable; and the conical wedge portion 12-1 is configured at the lower portion of the wedge bolt portion 12 to guide the wedge bolt portion 12 to easily enter into the spread portion 13 at the lower portion of the body thread portion 11-1.

In addition, since the fastener (unsigned) of the wedge bolt portion 12, as shown in FIG. 2, is formed to have one of hexagonal, pentagonal, quadrangular, triangular, linear, cross, and star shapes, it can be generally tightened or loosened by using screwdriver tools of various shapes.

That is, the wedge bolt 20, which is formed with the fastener at the upper portion thereof, is formed in various shapes such as hexagonal, pentagonal, quadrangular, triangular, linear, cross, and star shapes.

Meanwhile, as shown in B of FIG. 1, the body thread portion 11-2 according to another embodiment of the present invention includes the first hollow body thread portion and the second hollow body thread portion smaller in size than the first body thread portion.

That is, the body thread portion 11-2 includes the first body thread portion unsigned and the second body thread portion (unsigned).

In addition, the first body thread portion (unsigned) has a hollow screw thread formed on the upper portion of the inner circumferential surface of the anchor body 11, and the second body thread portion (unsigned) has a hollow screw thread, which is smaller in size than the first body thread portion, formed on the lower portion of the inner circumferential surface of the anchor body 11.

That is, the body thread portion 11-2 is configured differently from A in FIG. 1, and as shown in B of FIG. 1, the thread thereof has a double structure of the first and second body thread portions, and since the screw tightening is made smaller than the screwing of the object to be fixed and pushed more strongly than the body thread portion 11-1, the spread portion 13 is spread, thereby increasing the closely contact force with the object to be fixed.

Next, the spread portion 13 is formed in the lower portion of the anchor body 11, and the plurality of incision portions 14 are formed in the longitudinal direction of the anchor body 11 to be spaced apart at predetermined intervals along the circumference of the anchor body 11, so that the wedge portion 12-1 of the wedge bolt 20 is pushed in by the tightening force of the screw thread and may be spread.

In addition, the protruding portion 15 with a plurality of protrusions having a thread-shaped triangular structure is formed on the outer circumferential surface of the spread portion 13.

The protruding portion 15 with the plurality of protrusions having the thread-shaped triangular structure, when the spread portion 13 is spread, may be firmly fixed by being squashed into the object to be fixed such as concrete.

Therefore, according to the strong anchor 10 according to the embodiments of the present invention, when the wedge bolt 20 is rotated in the locking direction in the spread portion 13 of the anchor body 11 so that the wedge 12-1 is squashed and entered thereinto, the spread portion 13 may be firmly fixed by entering into the concrete.

For this reason, it is possible to install the strong anchor in a simpler and more robust method compared to the conventional working method.

In summary, the strong anchor 10 proposed by the present invention inserts the anchor body 1 into a hole drilled to a predetermined depth with a length of a certain standard in the object to be fixed such as concrete, and inserts the wedge bolt 20 into one side of the body thread portion 11-1.

In this case, the wedge bolt 20 is rotated in the tightening direction by turning one of a flat-head screwdriver, a phillips screwdriver, and one of triangular, quadrangular, pentagonal, hexagonal, and star-shaped wrenches according to the shape of the fastener thereof by using a hand or an electric drill.

Next, when the wedge portion 12-1 pushes and enters the spread portion 13 with the force of the screw thread according to the rotation of the wedge bolt 20, the protruding portion 15, which is fitted and spread into the spread part 13 and is formed with the plurality of protrusions on the outer circumferential surface of the spread portion 13, may be entered and fixed to concrete.

As described above, the strong anchor 10, which is simply and firmly fixed, allows the wedge bolt 20 to push and enter the spread portion 13, so that it may be safely, easily, and firmly fitted, and may be securely installed directly to an object be fixed such as concrete.

In addition, the strong anchor 10 proposed by the present invention may facilitate the demolition work by rotating the inserted wedge bolt 20 to loosen it and then pulling out and extracting it.

As described above, the present invention provides the strong anchor 10 that has a simple and robust fitting structure for installation in a hole drilled in concrete and that is also easy to dismantle, due to the structure rotatable in the tightening and loosening directions of the wedge bolt 20 in order to spread or close the spread portion of the anchor body 11.

The foregoing description is merely illustrative of the technical spirit of the present invention. It will be appreciated by those skilled in the art that various modifications and alterations can be made without departing from the essential characteristics of the present invention.

Therefore, the embodiments and the accompanying drawings disclosed in the present invention are not intended to limit the technical spirit or scope of the present invention, but to explain them, and the range of the technical spirit or scope of the present invention is not limited by the embodiments.

The protection range of the present invention should be construed by the claims below, and all technical ideas within an equivalent range thought should be construed as being included within the scope of the present invention.

### INDUSTRIAL APPLICABILITY

The present invention is used for cable tray support work, facility pipe support work, and fixing work for various devices for accommodating electric and communication cables of medium and large buildings such as apartments or buildings.

What is claimed is:

1. A strong anchor comprising:
a tubular anchor body;
a body thread portion formed on an inner circumferential surface of the anchor body;
a spread portion in which a plurality of incision grooves are formed in a lower portion of the anchor body;
a protruding portion formed with a plurality of protrusions having a triangular structure in a shape of a screw thread on an outer circumferential surface of the spread portion;
an insertion fixing portion forming a jaw on an upper portion of the anchor body and a wedge bolt inserted into the body thread portion,
wherein the wedge bolt includes
a wedge bolt portion that is rotated in a thread direction to correspond to the body thread portion and coupled thereto and a conical wedge portion integrally connected to a lower portion of the wedge bolt portion, and
when the wedge bolt is rotated in a locking direction, as the edge bolt is squashed into the lower portion of the body thread portion so that spread portion is widened, the protruding portion formed on the outer circumferential surface of the spread portion is widened and fixed to an object to be fixed.

2. The strong anchor of claim 1, wherein
the body thread portion includes a hollow first body thread portion and a hollow second body thread portion smaller than the first body thread portion.

3. The strong anchor of claim 1, wherein
the wedge bolt is separated into a conical wedge portion and a wedge bolt portion.

4. The strong anchor of claim 1, wherein
a fastener of the wedge bolt portion is formed to have one of hexagonal, pentagonal, quadrangular, triangular, linear, cross, and star shapes.
